(19) United States
(12) Patent Application Publication
(10) Pub. No.: US 2022/0293973 A1
(43) Pub. Date: Sep. 15, 2022

(54) FULL CELL SYSTEM

(71) Applicant: TOYOTA JIDOSHA KABUSHIKI KAISHA, Toyota-shi (JP)

(72) Inventors: Tomotaka ISHIKAWA, Nagoya-shi (JP); Makoto MORI, Susono-shi (JP); Tsuyoshi MARUO, Okazaki-shi (JP)

(21) Appl. No.: 17/654,704

(22) Filed: Mar. 14, 2022

(30) Foreign Application Priority Data
Mar. 15, 2021 (JP) 2021-041101

(51) Int. Cl. H01M 8/0444; H01M 8/04537; H01M 8/04791; H01M 8/04089; H01M 8/04082

(52) U.S. Cl. CPC H01M 8/0444; H01M 8/04544; H01M 8/04798; H01M 8/04097; H01M 8/04201

(57) ABSTRACT

A fuel cell system wherein the controller preliminarily stores a data group indicating a correlation between a voltage of the fuel cell and a concentration of impurity gas in the fuel gas; wherein the controller controls ON and OFF of the fuel gas supplier, wherein the controller operates the fuel gas supplier and determines whether or not the fuel cell voltage measured by the voltage sensor after an elapse of a predetermined time is less than a first threshold; and wherein, when the controller determines that the fuel cell voltage measured by the voltage sensor is less than the first threshold, the controller compares the voltage with the data group and determines that the concentration of the impurity gas in the fuel gas is higher than a predetermined concentration threshold.

The present disclosure relates to a fuel cell system.

### BACKGROUND

A fuel cell (FC) is a power generation device which is composed of a single unit fuel cell (hereinafter, it may be referred to as “cell”) or a fuel cell stack composed of stacked unit fuel cells (hereinafter, it may be referred to as “stack”) and which generates electrical energy by electrochemical reaction between fuel gas (e.g., hydrogen) and oxidant gas (e.g., oxygen). In many cases, the fuel gas and oxidant gas actually supplied to the fuel cell, are mixtures with gases that do not contribute to oxidation and reduction. Especially, the oxidant gas is often air containing oxygen.

Hereinafter, fuel gas and oxidant gas may be collectively and simply referred to as “reaction gas” or “gas”. Also, a single unit fuel cell and a fuel cell stack composed of stacked unit cells may be referred to as “fuel cell”.

In general, the unit fuel cell includes a membrane-electrode assembly (MEA).

The membrane electrode assembly has a structure such that a catalyst layer and a gas diffusion layer (or GDL, hereinafter it may be simply referred to as “diffusion layer”) are sequentially formed on both surfaces of a solid polymer electrolyte membrane (hereinafter, it may be simply referred to as “electrolyte membrane”). Accordingly, the membrane electrode assembly may be referred to as “membrane electrode gas diffusion layer assembly” (MEGA).

As needed, the unit fuel cell includes two separators sandwiching both sides of the membrane electrode gas diffusion layer assembly. In general, the separators have a structure such that a groove is formed as a reaction gas flow path on a surface in contact with the gas diffusion layer. The separators have electronic conductivity and function as a collector of generated electricity.

In the fuel electrode (anode) of the fuel cell, hydrogen (H₂) as the fuel gas supplied from the gas flow path and the gas diffusion layer, is protonated by the catalytic action of the catalyst layer, and the protonated hydrogen goes to the oxidant electrode (cathode) through the electrolyte membrane. An electron is generated at the same time, and it passes through an external circuit, does work, and then goes to the cathode. Oxygen (O₂) as the oxidant gas supplied to the cathode reacts with protons and electrons in the catalytic layer of the cathode, thereby generating water. The generated water gives appropriate humidity to the electrolyte membrane, and excess water penetrates the gas diffusion layer and then is discharged to the outside of the system.

Various studies have been made on fuel cell systems configured to be installed and used in fuel cell electric vehicles (hereinafter may be referred to as “vehicle”).

For example, Patent Literature 1 discloses a fuel cell control system capable of identifying the factor of a cell voltage drop.

Patent Literature 2 discloses a fuel storage system capable of preventing a fuel cell from failing without sacrificing manufacturing costs or degrees of freedom in layout design.
Patent Literature 1: Japanese Patent Application Laid-Open (JP-A) No. 2004-039322
Patent Literature 2: JP-A No. 2010-242952

In fuel cells, if the fuel gas contains hydrogen and impurities are contained in the fuel gas, not only a failure in efficient power generation but also an irreversible performance deterioration due to catalyst degradation are caused. Accordingly, it is important to control the purity of the fuel gas in the fuel cells.

In Patent Literature 1, an impurity gas concentration is estimated by a pressure sensor. The impurity gas concentration when a catalyst is poisoned with impurity gas, is a concentration on the order of several hundred ppb. Since the pressure of gas flowing through a gas flow path fluctuates, in Patent Literature 1, it is difficult to detect the influence of the pressure caused by low-concentration impurity gas, and there is a possibility that the presence or absence of the impurity gas cannot be determined accurately.

### SUMMARY

The disclosed embodiments were achieved in light of the above circumstances. An object of the disclosed embodiments is to provide a fuel cell system configured to accurately determine whether or not impurity gas is contained in fuel gas.

In a first embodiment, there is provided a fuel cell system,

wherein the fuel cell system comprises:

a fuel cell,

a voltage sensor for measuring a voltage of the fuel cell,

a fuel gas supplier for supplying hydrogen-containing fuel gas to the fuel cell,

a fuel gas supply flow path connecting a fuel gas inlet of the fuel cell and the fuel gas supplier,

an ejector disposed in the fuel gas supply flow path,

a circulation flow path connecting a fuel gas outlet of the fuel cell and the ejector to allow fuel off-gas discharged from the fuel gas outlet to be supplied to the fuel cell as circulation gas, and

a controller,

wherein the controller preliminarily stores a data group indicating a correlation between a voltage of the fuel cell and a concentration of impurity gas in the fuel gas;

wherein the controller controls ON and OFF of the fuel gas supplier,

wherein the controller operates the fuel gas supplier and determines whether or not the fuel cell voltage measured by the voltage sensor after an elapse of a predetermined time is less than a first threshold; and

wherein, when the controller determines that the fuel cell voltage measured by the voltage sensor is less than the first threshold, the controller compares the voltage with the data group and determines that the concentration of the impurity gas in the fuel gas is higher than a predetermined concentration threshold.

The first threshold may be a voltage measured by the voltage sensor when the fuel gas supplier is controlled to OFF and when the fuel cell is operated before the fuel gas is supplied to the fuel gas supplier.

The controller may determine whether or not the fuel gas was supplied to the fuel gas supplier.

When the controller determines that the fuel gas was supplied to the fuel gas supplier, the controller may operate the fuel gas supplier and determine whether or not the fuel cell voltage measured by the voltage sensor after the elapse of the predetermined time is less than the first threshold.

The impurity gas may be at least one selected from the group consisting of nitrogen, carbon monoxide, and hydrogen sulfide.

According to the fuel cell system of the disclosed embodiments, it can be accurately determined whether or not the impurity gas is contained in the fuel gas.

### BRIEF DESCRIPTION OF THE DRAWINGS

In the accompanying drawings,

FIG. 1 is a diagram showing an exemplary voltage behavior of a fuel cell when normal fuel gas having a prescribed hydrogen concentration is used;

FIG. 2 is a diagram showing an exemplary voltage behavior of a fuel cell when low-quality fuel gas having a low hydrogen concentration is used;

FIG. 3 is a diagram showing an exemplary voltage behavior of a fuel cell when low-quality fuel gas containing hydrogen sulfide (H 2S), which is a catalyst poisoning substance, as an impurity, is used;

FIG. 4 is a schematic configuration diagram of an example of the fuel cell system of the disclosed embodiments;

FIG. 5 is a flowchart illustrating an example of control of the fuel cell system of the disclosed embodiments; and

FIG. 6 is a flowchart illustrating another example of control of the fuel cell system of the disclosed embodiments.

### DETAILED DESCRIPTION

The fuel cell system of the disclosed embodiments is a fuel cell system,

wherein the fuel cell system comprises:

a fuel cell,

a voltage sensor for measuring a voltage of the fuel cell,

a fuel gas supplier for supplying hydrogen-containing fuel gas to the fuel cell,

a fuel gas supply flow path connecting a fuel gas inlet of the fuel cell and the fuel gas supplier,

an ejector disposed in the fuel gas supply flow path,

a circulation flow path connecting a fuel gas outlet of the fuel cell and the ejector to allow fuel off-gas discharged from the fuel gas outlet to be supplied to the fuel cell as circulation gas, and

a controller,

wherein the controller preliminarily stores a data group indicating a correlation between a voltage of the fuel cell and a concentration of impurity gas in the fuel gas;

wherein the controller controls ON and OFF of the fuel gas supplier,

wherein the controller operates the fuel gas supplier and determines whether or not the fuel cell voltage measured by the voltage sensor after an elapse of a predetermined time is less than a first threshold; and

wherein, when the controller determines that the fuel cell voltage measured by the voltage sensor is less than the first threshold, the controller compares the voltage with the data group and determines that the concentration of the impurity gas in the fuel gas is higher than a predetermined concentration threshold.

If low-quality fuel gas is filled into a fuel gas supplier (such as the fuel tank of a fuel cell system) and the low-quality fuel gas contains inert gas in the predetermined concentration or more, since the concentration of hydrogen in the fuel gas in the fuel tank decreases less than an estimated value, impurities are gradually accumulated in the fuel cell during the operation of the fuel cell and adsorbs onto the catalyst. As a result, the voltage of the fuel cell drops, and the fuel cell deteriorates.

Accordingly, in the disclosed embodiments, the fuel gas is filled into the fuel tank when the fuel cell system is stopped, and the voltage of the fuel cell is acquired. The fuel gas voltage acquired at this time serves as a reference value. Then, when the fuel gas is supplied from the outside, the voltage of the fuel cell is acquired again. and the acquired fuel cell voltage is compared with the reference value, thereby determining whether or not the supplied fuel gas contains the impurity gas in a concentration exceeding the reference value, that is, whether or not the supplied fuel gas is the low-quality fuel gas. Then, the concentration of the impurity gas or hydrogen in the fuel gas in the fuel tank is estimated from the acquired fuel cell voltage, and the fuel gas supply/discharge control is changed in accordance with the estimated impurity gas concentration or the estimated hydrogen concentration. Then, the information on the hydrogen station where the low-quality fuel gas was filled into the fuel cell system, is shared with other vehicles by the information and communication technology (ICT). Accordingly, filling the low-quality fuel gas into the fuel tank of other vehicles, can be avoided. Also, the information on the hydrogen concentrations of fuel gases supplied at hydrogen stations can be shared with other vehicles by the ICT.

In the disclosed embodiments, a reference fuel cell voltage is acquired; the voltage of the fuel cell is acquired after supplying the fuel gas and after consuming a certain potion of the supplied fuel gas; and by comparing the acquired voltage with the reference fuel cell voltage value, it can be determined whether the fuel gas contains the impurity gas in the predetermined concentration or more.

There are several types of impurity gases that can poison catalysts. According to the disclosed embodiments, since the voltage of the fuel cell is used to determine whether or not the impurity gas is contained in the fuel gas, the determination can be made regardless of the type of the impurity gas.

According to the disclosed embodiments, even when low-concentration impurity gas is contained in the fuel gas, the presence or absence of the impurity gas or the concentration of the impurity gas can be accurately determined. Accordingly, catalyst poisoning is suppressed.

In the present disclosure, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.

In the disclosed embodiments, the impurity gas may be nitrogen, carbon monoxide, hydrogen sulfide, or the like.

In the disclosed embodiments, a poisoning substance may be carbon monoxide, hydrogen sulfide, or the like.

In general, the fuel cell system of the disclosed embodiments is installed and used in a vehicle including a motor as a driving source.

The fuel cell system of the disclosed embodiments may be installed and used in a vehicle that can be run by the power of a secondary cell.

The vehicle may be a fuel cell electric vehicle.

The vehicle may include the fuel cell system of the disclosed embodiments.

The motor is not particularly limited, and it may be a conventionally-known driving motor.

The fuel cell system of the disclosed embodiments includes the fuel cell.

The fuel cell may be a fuel cell composed of only one unit fuel cell, or it may be a fuel cell stack composed of stacked unit fuel cells.

The number of the stacked unit fuel cells is not particularly limited. For example, 2 to several hundred unit fuel cells may be stacked; 2 to 200 unit fuel cells may be stacked; or 2 to 300 unit fuel cells may be stacked.

The fuel cell stack may include an end plate at both stacking-direction ends of each unit fuel cell.

Each unit fuel cell includes at least a membrane electrode gas diffusion layer assembly.

The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes the cathode catalyst layer and the cathode-side gas diffusion layer.

The anode (fuel electrode) includes the anode catalyst layer and the anode-side gas diffusion layer.

The cathode catalyst layer and the anode catalyst layer are collectively referred to as “catalyst layer”. As the anode catalyst and the cathode catalyst, examples include, but are not limited to, platinum, (Pt) and ruthenium (Ru). As a catalyst-supporting material and a conductive material, examples include, but are not limited to, a carbonaceous material such as carbon.

The cathode-side gas diffusion layer and the anode-side gas diffusion layer are collectively referred to as “gas diffusion layer”.

The gas diffusion layer may be a gas-permeable electroconductive member or the like.

As the electroconductive member, examples include, but are not limited to, a porous carbon material such as carbon cloth and carbon paper, and a porous metal material such as metal mesh and foam metal.

The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

As needed, each unit fuel cell may include two separators sandwiching both sides of the membrane electrode gas diffusion layer assembly. One of the two separators is an anode-side separator, and the other is a cathode-side separator. In the disclosed embodiments, the anode-side separator and the cathode-side separator are collectively referred to as “separator”.

The separator may include supply and discharge holes for allowing the reaction gas and the refrigerant to flow in the stacking direction of the unit fuel cells. As the refrigerant, for example, a mixed solution of ethylene glycol and water may be used to prevent freezing at low temperature.

As the supply hole, examples include, but are not limited to, a fuel gas supply hole, an oxidant gas supply hole, and a refrigerant supply hole.

As the discharge hole, examples include, but are not limited to, a fuel gas discharge hole, an oxidant gas discharge hole, and a refrigerant discharge hole.

The separator may include one or more fuel gas supply holes, one or more oxidant gas supply holes, one or more refrigerant supply holes, one or more fuel gas discharge holes, one or more oxidant gas discharge holes, and one or more refrigerant discharge holes.

The separator may include a reactant gas flow path on a surface in contact with the gas diffusion layer. Also, the separator may include a refrigerant flow path for keeping the temperature of the fuel cell constant on the opposite surface to the surface in contact with the gas diffusion layer.

When the separator is the anode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The anode-side separator may include a fuel gas flow path for allowing the fuel gas to flow from the fuel gas supply hole to the fuel gas discharge hole, on the surface in contact with the anode-side gas diffusion layer. The anode-side separator may include a refrigerant flow path for allowing the refrigerant to flow from the refrigerant supply hole to the refrigerant discharge hole, on the opposite surface to the surface in contact with the anode-side gas diffusion layer.

When the separator is the cathode-side separator, it may include one or more fuel gas supply holes, one or more oxidant gas supply holes, one or more refrigerant supply holes, one or more fuel gas discharge holes, one or more oxidant gas discharge holes, and one or more refrigerant discharge holes. The cathode-side separator may include an oxidant gas flow path for allowing the oxidant gas to flow from the oxidant gas supply hole to the oxidant gas discharge hole, on the surface in contact with the cathode-side gas diffusion layer. The cathode-side separator may include a refrigerant flow path for allowing the refrigerant to flow from the refrigerant supply hole to the refrigerant discharge hole, on the opposite surface to the surface in contact with the cathode-side gas diffusion layer.

The separator may be a gas-impermeable electroconductive member or the like. As the electroconductive member, examples include, but are not limited to, gas-impermeable dense carbon obtained by carbon densification, and a metal plate (such as an iron plate, an aluminum plate and a stainless-steel plate) obtained by press-molding. The separator may function as a collector.

The fuel cell stack may include a manifold such as an inlet manifold communicating between the supply holes and an outlet manifold communicating between the discharge holes.

As the inlet manifold, examples include, but are not limited to, an anode inlet manifold, a cathode inlet manifold, and a refrigerant inlet manifold.

As the outlet manifold, examples include, but are not limited to, an anode outlet manifold, a cathode outlet manifold, and a refrigerant outlet manifold.

The fuel cell system includes, as the fuel gas system of the fuel cell, the fuel gas supplier, the fuel gas supply flow path, the ejector, the voltage sensor, the circulation flow path, and the controller.

The fuel gas supplier supplies the hydrogen-containing fuel gas to the fuel cell. More specifically, the fuel gas supplier supplies the hydrogen-containing fuel gas to the anode of the fuel cell.

As the fuel gas supplier, examples include, but are not limited to, a fuel tank such as a liquid hydrogen tank and a compressed hydrogen tank.

The fuel gas supplier is electrically connected to the controller. In the fuel gas supplier, ON/OFF of the fuel gas supply to the fuel cell may be controlled by controlling the opening and closing of the main shutoff valve of the fuel gas supplier according to a control signal from the controller.

The fuel gas supply flow path connects the fuel gas inlet of the fuel cell and the fuel gas supplier. The fuel gas supply flow path allows the fuel gas to be supplied to the anode of the fuel cell. The fuel gas inlet may be the fuel gas supply hole, the anode inlet manifold or the like.

In the fuel gas supply flow path, the ejector is disposed.

For example, the ejector may be disposed at a junction with the circulation flow path on the fuel gas supply flow path. The ejector supplies a mixed gas containing the fuel gas and circulation gas to the anode of the fuel cell. As the ejector, a conventionally-known ejector may be used.

A pressure control valve and a medium-pressure hydrogen sensor may be disposed in a region between the fuel gas supplier and ejector of the fuel gas supply flow path.

The pressure control valve controls the pressure of the fuel gas supplied from the fuel gas supplier to the ejector.

The pressure control valve is electrically connected to the controller. The pressure of the fuel gas supplied to the ejector may be controlled by controlling the opening/closing, opening degree or the like of the pressure control valve by the controller.

The medium-pressure hydrogen sensor is electrically connected to the controller. The controller detects the fuel cell pressure measured by the medium-pressure hydrogen sensor. The pressure of the fuel gas supplied to the ejector may be controlled by controlling the opening/closing, opening degree or the like of the pressure control valve, based on the detected pressure.

The voltage sensor measures the voltage of the fuel cell.

The voltage sensor is electrically connected to the controller. The controller detects the fuel cell voltage measured by the voltage sensor.

As the voltage sensor, a conventionally-known voltmeter or the like can be used.

The position of the voltage sensor is not particularly limited, as long as the voltage of the fuel cell can be measured.

The circulation flow path connects the fuel gas outlet of the fuel cell and the ejector.

The circulation flow path allows the fuel off-gas, which is the fuel gas discharged from the fuel gas outlet of the fuel cell, to be recovered and supplied to the fuel cell as the circulation gas.

The circulation flow path may connect to the ejector disposed in the fuel gas supply flow path, thereby merging with the fuel gas supply flow path.

The circulation pump may be disposed in the circulation flow path. The circulation pump circulates the fuel off-gas as the circulation gas. The circulation pump may be electrically connected to the controller, and the flow rate of the circulation gas may be controlled by controlling ON/OFF, rotational frequency, etc., of the circulation pump by the controller.

The fuel gas system may include a fuel off-gas discharge flow path.

The fuel off gas discharge flow path may connect the fuel gas outlet of the fuel cell and the outside of the fuel cell system.

The fuel off-gas discharge flow path may branch from the circulation flow path.

The circulation flow path may branch from the fuel off-gas discharge flow path and connect to the ejector disposed in the fuel gas supply flow path, thereby merging with the fuel gas supply flow path.

The fuel off-gas discharge flow path discharges, to the outside of the fuel cell system, the fuel off-gas discharged from the fuel gas outlet of the fuel cell. The fuel gas outlet may be the fuel gas discharge hole, the anode outlet manifold, or the like.

The vent and discharge valve (the fuel off-gas discharge valve) may be disposed in the fuel off-gas discharge flow path. The vent and discharge valve is disposed downstream from the gas-liquid separator in the fuel off-gas discharge flow path.

The vent and discharge valve allows the fuel off-gas, water and the like to be discharged to the outside (of the system). The outside may be the outside of the fuel cell system, or it may be the outside of the vehicle.

The vent and discharge valve may be electrically connected to the controller, and the flow rate of the fuel off-gas discharged to the outside may be controlled by controlling the opening and closing of the vent and discharge valve by the controller. By controlling the opening degree of the vent and discharge valve, the pressure of the fuel gas supplied to the anode of the fuel cell (anode pressure) may be controlled.

The fuel off-gas may contain the fuel gas that has passed through the anode without reacting, and the water generated at the cathode and delivered to the anode. In some cases, the fuel off-gas contains corroded substances generated in the catalyst layer, the electrolyte membrane or the like, and the oxidant gas or the like allowed to be supplied to the anode during a purge.

The gas-liquid separator (anode gas-liquid separator) may be disposed in the fuel off-gas discharge flow path.

The gas-liquid separator may be disposed at the branch point of the fuel off-gas discharge flow path and the circulation flow path.

The fuel off-gas discharge flow path may branch from the circulation flow path through the gas-liquid separator.

The circulation flow path may branch from the fuel off-gas discharge flow path through the gas-liquid separator and connect to the ejector disposed in the fuel gas supply flow path, thereby merging with the fuel gas supply flow path.

The gas-liquid separator is disposed upstream from the vent and discharge valve of the fuel off-gas discharge flow path.

The gas-liquid separator separates the water and fuel gas contained in the fuel off-gas, which is the fuel gas discharged from the fuel gas outlet. Accordingly, the fuel gas may be returned to the circulation flow path as the circulation gas, or unnecessary gas, water and the like may be discharged to the outside by opening the vent and discharge valve of the fuel off-gas discharge flow path. In addition, the gas-liquid separator can suppress the flow of excess water into the circulation flow path. Accordingly, the occurrence of freezing of the circulation pump or the like due to the water, can be suppressed.

As the oxidant gas system of the fuel cell, the fuel cell system may include an oxidant gas supplier, an oxidant gas supply flow path, an oxidant off-gas discharge flow path, an oxidant gas bypass flow path, a bypass valve, and an oxidant gas flow rate sensor.

The oxidant gas supplier supplies the oxidant gas to the fuel cell. More specifically, the oxidant gas supplier supplies the oxidant gas to the cathode of the fuel cell.

As the oxidant gas supplier, for example, an air compressor may be used.

The oxidant gas supplier is electrically connected to the controller. The oxidant gas supplier is driven according to a control signal from the controller. At least one selected from the group consisting of the flow rate and pressure of the oxidant gas supplied from the oxidant gas supplier to the cathode, may be controlled by the controller.

The oxidant gas supply flow path connects the oxidant gas supplier and the oxidant gas inlet of the fuel cell. The oxidant gas supply flow path allows the oxidant gas to be supplied from the oxidant gas supplier to the cathode of the fuel cell. The oxidant gas inlet may be the oxidant gas supply hole, the cathode inlet manifold, or the like.

The oxidant off-gas discharge flow path is connected to the oxidant gas outlet of the fuel cell. The oxidant off-gas discharge flow path allows the oxidant off-gas, which is the oxidant gas discharged from the cathode of the fuel cell, to be discharged to the outside. The oxidant gas outlet may be the oxidant gas discharge hole, the cathode outlet manifold, or the like.

The oxidant off-gas discharge flow path may be provided with an oxidant gas pressure control valve.

The oxidant gas pressure control valve is electrically connected to the controller. By opening the oxidant gas pressure control valve by the controller, the oxidant off-gas, which is the reacted oxidant gas, is discharged to the outside from the oxidant off-gas discharge flow path. The pressure of the oxidant gas supplied to the cathode (cathode pressure) may be controlled by controlling the opening degree of the oxidant gas pressure control valve.

The oxidant gas bypass flow path branches from the oxidant gas supply flow path, bypasses the fuel cell, and connects the branch of the oxidant gas supply flow path and the junction of the oxidant off-gas discharge flow path.

The bypass valve is disposed in the oxidant gas bypass flow path.

The bypass valve is electrically connected to the controller. By opening the bypass valve by the controller, when the supply of the oxidant gas to the fuel cell is unnecessary, the oxidant gas can bypass the fuel cell and be discharged to the outside from the oxidant off-gas discharge flow path.

The oxidant gas flow rate sensor is disposed in the oxidant gas supply flow path.

The oxidant gas flow rate sensor detects the flow rate of the oxidant gas in the oxidant gas system. The oxidant gas flow rate sensor is electrically connected to the controller. The controller may estimate the rotational frequency of the air compressor from the flow rate of the oxidant gas detected by the oxidant gas flow rate sensor. The oxidant gas flow rate sensor may be disposed upstream from the oxidant gas supplier of the oxidant gas supply flow path.

As the oxidant gas flow rate sensor, a conventionally-known flow meter or the like may be used.

The fuel cell system may include a refrigerant supplier and a refrigerant circulation flow path as the cooling system of the fuel cell.

The refrigerant circulation flow path communicates between the refrigerant supply and discharge holes provided in the fuel cell, and it allows the refrigerant supplied from the refrigerant supplier to be circulated inside and outside the fuel cell.

The refrigerant supplier is electrically connected to the controller. The refrigerant supplier is driven according to a control signal from the controller. The flow rate of the refrigerant supplied from the refrigerant supplier to the fuel cell, is controlled by the controller. The temperature of the fuel cell may be controlled thereby.

As the refrigerant supplier, examples include, but are not limited to, a cooling water pump.

The refrigerant circulation flow path may be provided with a radiator for heat dissipation from the cooling water.

The refrigerant circulation flow path may be provided with a reserve tank for storing the refrigerant.

The fuel cell system may include a secondary cell.

The secondary cell (battery) may be any chargeable and dischargeable cell. For example, the secondary cell may be a conventionally known secondary cell such as a nickel-hydrogen secondary cell and a lithium ion secondary cell. The secondary cell may include a power storage element such as an electric double layer capacitor. The secondary cell may have a structure such that a plurality of secondary cells are connected in series. The secondary cell supplies power to the motor, the oxidant gas supplier and the like. The secondary cell may be rechargeable by a power source outside the vehicle, such as a household power supply. The secondary cell may be charged by the output power of the fuel cell. The charge and discharge of the secondary cell may be controlled by the controller.

The controller physically includes a processing unit such as a central processing unit (CPU), a memory device such as a read-only memory (ROM) and a random access memory (RAM), and an input-output interface. The ROM is used to store a control program, control data and so on to be processed by the CPU, and the RAM is mainly used as various workspaces for control processing. The controller may be a control device such as an electronic control unit (ECU).

The controller may be electrically connected to an ignition switch which may be installed in the vehicle. The controller may be operable by an external power supply even if the ignition switch is turned OFF.

The controller preliminarily stores the data group indicating the correlation between the voltage of the fuel cell and the concentration of the impurity gas in the fuel gas. When the impurity gas is one type of impurity gas, by preliminarily storing the data group indicating the correlation between the voltage of the fuel gas and the concentration of the impurity gas in the fuel gas, the concentration of the impurity gas can be estimated from the measured fuel cell voltage. When the impurity gas is two or more types of impurity gases, by preliminarily storing the data group indicating the correlation between the voltage of the fuel cell and the concentrations of the impurity gases in the fuel gas, the types and concentrations of the impurity gases can be estimated from the measured fuel cell voltage.

The controller controls ON and OFF of the fuel gas supplier.

The controller operates the fuel gas supplier and determines whether or not the fuel cell voltage measured by the voltage sensor after the elapse of the predetermined time is less than the first threshold.

When the controller determines that the fuel cell voltage measured by the voltage sensor is less than the first threshold, the controller compares the voltage with the data group indicating the correlation between the voltage of the fuel gas and the concentration of the impurity gas in the fuel gas, and the controller determines that the concentration of the impurity gas in the fuel gas is higher than the predetermined concentration threshold.

When the controller determines that the fuel cell voltage measured by the voltage sensor is equal to or more than the first threshold, the controller may determine that the impurity gas is not contained in the fuel gas. Also when the controller determines that the fuel cell voltage measured by the voltage sensor is equal to or more than the first threshold, the controller may compare the voltage with the preliminarily stored data group indicating the correlation between the voltage of the fuel cell and the concentration of the impurity gas in the fuel gas, and the controller may determine that the concentration of the impurity gas in the fuel gas is equal to or less than the predetermined concentration threshold.

The predetermined concentration threshold may be the allowable concentration of the impurity gas which may be contained in the fuel gas, and it may be appropriately set according to the performance of the fuel cell.

Determining that the concentration of the impurity gas in the fuel gas is higher than the predetermined concentration threshold, means the following: it is determined that the fuel gas contains the impurity gas in a concentration exceeding the allowable concentration. Determining that the fuel gas contains the impurity gas in a concentration exceeding the allowable concentration, means that the impurity gas is contained in the fuel gas.

The controller may determine whether or not the fuel gas was supplied to the fuel gas supplier. When the controller determines that the fuel gas was supplied to the fuel gas supplier, the controller may operate the fuel gas supplier and determine whether or not the fuel cell voltage measured by the voltage sensor after the elapse of the predetermined time is less than the first threshold. Accordingly, every time the fuel gas is supplied from the outside, the controller can determine whether or not the supplied fuel gas contains the impurity gas in a concentration exceeding the predetermined reference value.

The first threshold value may be a voltage serving as a reference for determining whether or not the fuel gas contains the impurity gas. The first threshold may be the fuel cell voltage at the time of power generation of the fuel cell by use of normal fuel gas that contains hydrogen in the preliminarily-stored, predetermined concentration. Also, every time the fuel gas is supplied from the outside, in order to accurately determine whether or not the supplied fuel gas contains the impurity gas in the predetermined concentration, the first threshold may be the voltage measured by the voltage sensor when the fuel gas supplier is controlled to OFF and when the fuel cell is operated before the fuel gas is supplied to the fuel gas supplier

The predetermined time after the operation of the fuel gas supplier may be a period of time between when the fuel gas filled into the fuel gas supplier is supplied to the fuel cell and when the voltage of the fuel cell when the fuel gas filled into the fuel gas supplier is used, is allowed to be measured.

The fuel cell voltage measured by the voltage sensor after the elapse of the predetermined time after the operation of the fuel gas supplier, may be a voltage when the fuel cell uses the fuel gas filled into the fuel gas supplier.

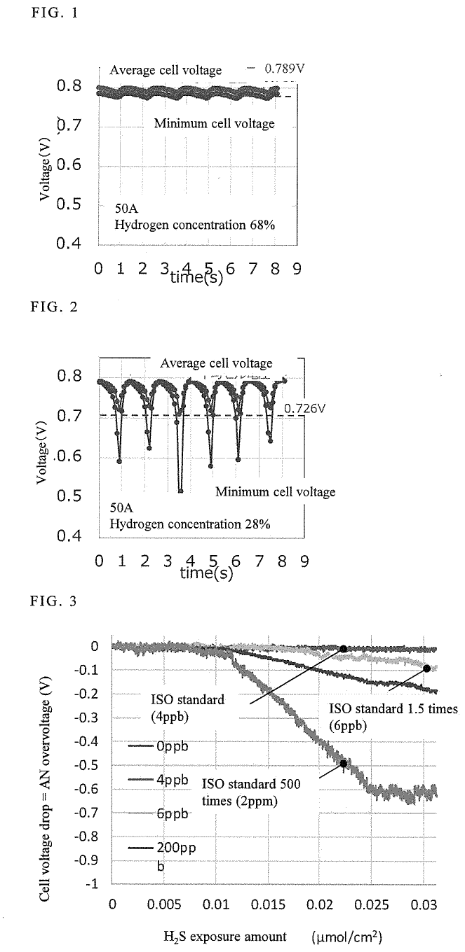

FIG. 1 is a diagram showing an exemplary voltage behavior of a fuel cell when normal fuel gas having a prescribed hydrogen concentration is used.

FIG. 2 is a diagram showing an exemplary voltage behavior of a fuel cell when low-quality fuel gas having a low hydrogen concentration is used.

FIG. 3 is a diagram showing an exemplary voltage behavior of a fuel cell when low-quality fuel gas containing hydrogen sulfide (H 2S), which is a catalyst poisoning substance, as an impurity, is used.

As shown in FIGS. 1 to 3, when the hydrogen concentration in the fuel gas is low, and when the impurity gas is contained in the fuel gas, the voltage of the fuel cell is lower than the voltage of the fuel cell when the normal fuel gas is used.

Accordingly, to determine the type and concentration of the impurity gas, a data group indicating the relationship between the type and concentration of the impurity gas and the voltage of the fuel cell when the fuel gas containing the impurity gas is used, may be preliminarily stored. Then, the voltage of the fuel cell when the normal fuel gas containing hydrogen in the predetermined concentration is used, is measured as the reference. Then, the voltage of the fuel cell when the fuel gas filled into the fuel gas supplier is used, is compared with the voltage of the fuel cell when the normal fuel gas containing hydrogen in the prescribed concentration is used. Accordingly, it can be determined whether or not the fuel gas filled into the fuel gas supplier contains the impurity gas. Also, the type and concentration of the impurity gas contained in the fuel gas filled into the fuel gas supplier, can be determined from the measured voltage behavior.

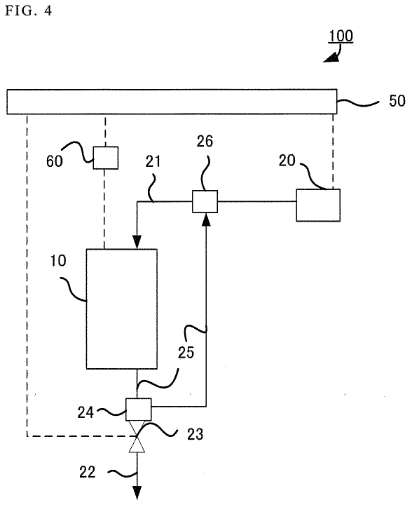

FIG. 4 is a schematic configuration diagram of an example of the fuel cell system of the disclosed embodiments. A fuel cell system 100 shown in FIG. 4 includes a fuel cell 10, a fuel gas supplier 20, a fuel gas supply flow path 21, a fuel off-gas discharge flow path 22, an vent and discharge valve 23, a gas-liquid separator 24, a circulation flow path 25, an ejector 26, a controller 50, and a voltage sensor 60. In FIG. 4, only the fuel gas system is illustrated, and other systems such as the oxidant gas system and the cooling system are not illustrated.

The voltage sensor 60 measures the voltage of the fuel cell 10. As indicated by a dashed line, the voltage sensor 60 is electrically connected to the controller 50 and sends the measured fuel cell voltage to the controller 50.

The gas-liquid separator 24 is disposed at the branch point of the fuel-off gas discharge flow path 22 and the circulation flow path 25. The gas-liquid separator 24 separates the fuel gas and water from the fuel-off gas which is the fuel gas discharged from the anode outlet, and it returns the fuel gas as circulation gas.

The ejector 26 is disposed at the junction of the circulation flow path 25 with the fuel gas supply flow path 21.

The controller 50 is electrically connected to the fuel gas supplier 20, and it controls the supply of the fuel gas from the fuel gas supplier 20, based on the result of measuring the voltage of the fuel cell.

The controller 50 is electrically connected to the vent and discharge valve 23. As needed, it opens the vent and discharge valve 23 and discharges unnecessary gas, moisture or the like from the fuel-off gas discharge flow path 22 to the outside.

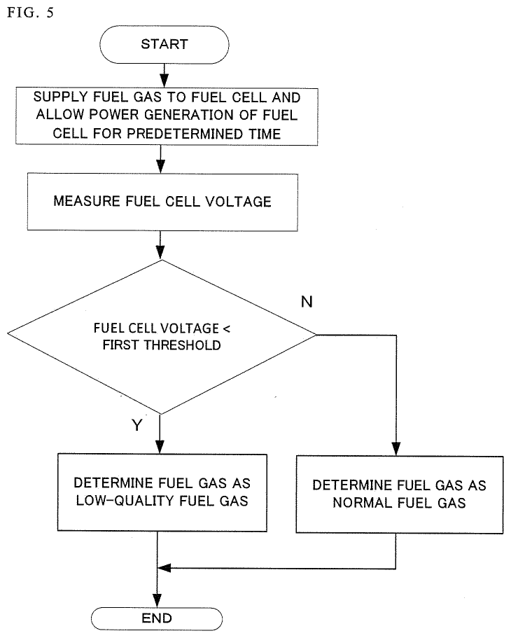

FIG. 5 is a flowchart illustrating an example of control of the fuel cell system of the disclosed embodiments.

First, the controller operates the fuel gas supplier to supply the fuel gas to the fuel cell and allow power generation of the fuel cell for a predetermined time.

Then, the voltage sensor measures the voltage of the fuel cell.

The controller determines whether or not the fuel cell voltage measured by the voltage sensor is less than the predetermined first threshold.

When the controller determines that the fuel cell voltage measured by the voltage sensor is equal to or more than the predetermined first threshold, the controller determines that the fuel gas is the normal fuel gas, and the controller ends the control.

On the other hand, when the controller determines that the fuel cell voltage measured by the voltage sensor is less than the predetermined first threshold, the controller determines that the fuel gas is the low-quality fuel gas containing the impurity gas in a concentration exceeding the reference value, and the controller ends the control.

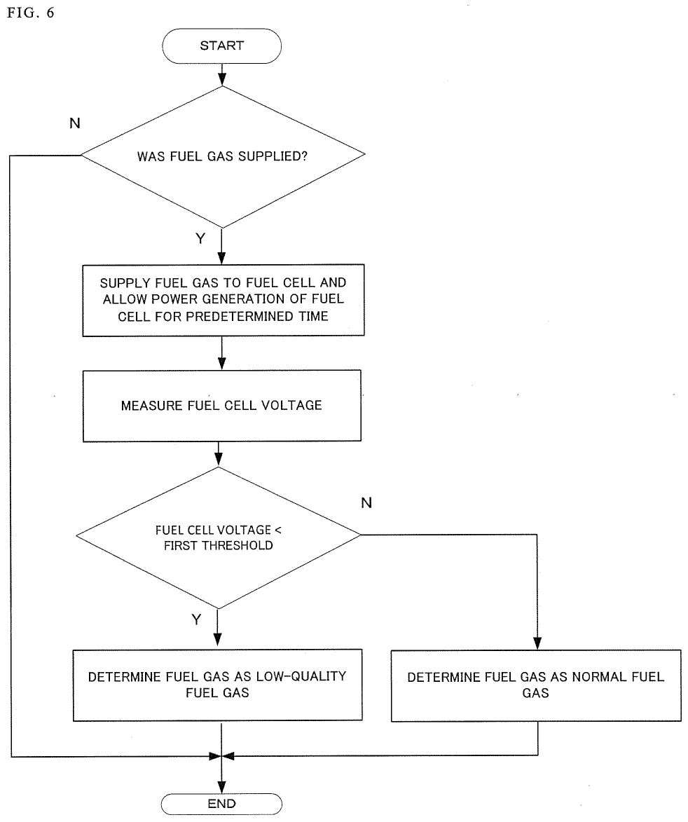

FIG. 6 is a flowchart illustrating another example of control of the fuel cell system of the disclosed embodiments.

First, the controller determines whether or not the fuel gas was supplied to the fuel gas supplier.

When the controller determines that the fuel gas was not supplied to the fuel gas supplier, the controller ends the control.

On the other hand, when the controller determines that the fuel gas was supplied to the fuel gas supplier, the controller operates the fuel gas supplier to supply the fuel gas to the fuel cell and allow power generation of the fuel cell for a predetermined time.

Then, the voltage sensor measures the voltage of the fuel cell.

The controller determines whether or not the fuel cell voltage measured by the voltage sensor is less than the predetermined first threshold.

When the controller determines that the fuel cell voltage measured by the voltage sensor is equal to or more than the predetermined first threshold, the controller determines that the fuel gas is the normal fuel gas, and the controller ends the control.

On the other hand, when the controller determines that the fuel cell voltage measured by the voltage sensor is less than the predetermined first threshold, the controller determines that the fuel gas is the low-quality fuel gas containing the impurity gas in a concentration exceeding the reference value, and the controller ends the control.

When the controller determines that the fuel gas is the low-quality fuel gas, the controller may perform the following control, for example.

The concentration of the impurity gas or hydrogen in the low-quality fuel gas is estimated. In accordance with the estimated impurity gas or hydrogen concentration, the hydrogen concentration constant in the fuel gas supplier is changed, and the fuel gas supply control, the fuel gas discharge control and the like are changed.

Changing the hydrogen concentration constant in the fuel gas supplier means, for example changing the hydrogen concentration constant from 99.5% to 95% when the reference hydrogen concentration of the fuel gas is 99.5% and the estimated hydrogen concentration of the low-quality fuel gas is 95%. Then, in accordance with the changed hydrogen concentration constant, the fuel gas supply control, the fuel gas discharge control, and the like may be changed.

As the change to the fuel gas supply control, examples include, but are not limited to, increasing the pressure of the fuel gas supplied to the fuel cell to increase the concentration of the hydrogen supplied to the fuel cell.

As the change to the fuel gas discharge control, examples include, but are not limited to, increasing the opening frequency of the vent and discharge valve disposed in the fuel-off gas discharge flow path to quickly discharge the impurity gas to the outside of the fuel cell system.

When the controller determines that the fuel gas is the low-quality fuel gas, the type of the impurity gas contained in the low-quality fuel gas may be estimated, for example. When the controller estimates that the type of the impurity gas contained in the low-quality fuel gas is nitrogen, the low-quality fuel gas is determined to be a fuel gas having a low hydrogen concentration. In this case, the power generation of the fuel cell is allowed to be continued. On the other hand, when the controller estimates that the type of the impurity gas contained in the low-quality fuel gas is a poisoning substance such as carbon monoxide and hydrogen sulfide, the low-quality fuel gas is determined to be fuel gas mixed with the poisoning substance. In this case, catalyst degradation occurs when the power generation of the fuel cell is continued. Accordingly, a measure to stop the fuel gas supply to the fuel cell and prohibit the power generation of the fuel cell, may be adopted. Accordingly, the deterioration of the fuel cell is suppressed.

When the controller determines that the fuel gas is the low-quality fuel gas, the information on the hydrogen station where the low-quality fuel gas was filled into the fuel cell system, may be shared with other vehicles by the information communication technology (ICT) such as a data communication module (DCM) which may be installed in the vehicle. Accordingly, filling the low-quality fuel gas into the fuel gas supplier of other vehicles is prevented. Also, the information on the hydrogen concentrations of fuel gases supplied at hydrogen stations may be shared with other vehicles by the ICT.

### REFERENCE SIGNS LIST

10: Fuel cell
20: Fuel gas supplier
21: Fuel gas supply flow path
22: Fuel off-gas discharge flow path
23: Vent and discharge valve
24: Gas-liquid separator
25: Circulation flow path
26: Ejector
50: Controller
60: Voltage sensor
100: Fuel cell system

1. A fuel cell system,
wherein the fuel cell system comprises:
a fuel cell,
a voltage sensor for measuring a voltage of the fuel cell,
a fuel gas supplier for supplying hydrogen-containing fuel gas to the fuel cell,
a fuel gas supply flow path connecting a fuel gas inlet of the fuel cell and the fuel gas supplier,
an ejector disposed in the fuel gas supply flow path,
a circulation flow path connecting a fuel gas outlet of the fuel cell and the ejector to allow fuel off-gas discharged from the fuel gas outlet to be supplied to the fuel cell as circulation gas, and
a controller,
wherein the controller preliminarily stores a data group indicating a correlation between a voltage of the fuel cell and a concentration of impurity gas in the fuel gas;
wherein the controller controls ON and OFF of the fuel gas supplier,
wherein the controller operates the fuel gas supplier and determines whether or not the fuel cell voltage measured by the voltage sensor after an elapse of a predetermined time is less than a first threshold; and
wherein, when the controller determines that the fuel cell voltage measured by the voltage sensor is less than the first threshold, the controller compares the voltage with the data group and determines that the concentration of the impurity gas in the fuel gas is higher than a predetermined concentration threshold.

2. The fuel cell system according to claim 1, wherein the first threshold is a voltage measured by the voltage sensor when the fuel gas supplier is controlled to OFF and when the fuel cell is operated before the fuel gas is supplied to the fuel gas supplier.

3. The fuel cell system according to claim 1,
wherein the controller determines whether or not the fuel gas was supplied to the fuel gas supplier, and
wherein, when the controller determines that the fuel gas was supplied to the fuel gas supplier, the controller operates the fuel gas supplier and determines whether or not the fuel cell voltage measured by the voltage sensor after the elapse of the predetermined time is less than the first threshold.

4. The fuel cell system according to claim 1, wherein the impurity gas is at least one selected from the group consisting of nitrogen, carbon monoxide, and hydrogen sulfide.
